(19) United States
(12) Patent Application Publication
(10) Pub. No.: US 2026/0331775 A1
(43) Pub. Date: Oct. 22, 2026

(54) ANTENNA DEVICE

(71) Applicant: Getac Technology Corporation, New Taipei City (TW)

(72) Inventor: Bo-Ting LAI, Taipei City (TW)

(21) Appl. No.: 19/260,728

(22) Filed: Jul. 7, 2025

(30) Foreign Application Priority Data
Apr. 18, 2025 (CN) 202510490686.5

(51) Int. Cl. H01Q 9/06; H01P 1/203

(52) U.S. Cl. CPC H01Q 9/065; H01P 1/203

(57) ABSTRACT

The present disclosure provides an antenna device, which includes an antenna pattern and a microstrip filter. The microstrip filter is disposed on a display panel surface and is electrically connected to the antenna pattern. By integrating the microstrip filter and the antenna pattern together through the antenna device, the space between the substrate and the filter can be saved, which has advantages in space utilization. Furthermore, it can also reduce costs, and simplify the circuit design in the research and development stage, making the device easier for the factory to assemble and reducing the assembly labor cost.

### CROSS-REFERENCE TO RELATED APPLICATION

This application claims priority to China Application Serial Number 202510490686.5, filed Apr. 18, 2025, which is herein incorporated by reference in its entirety.

### BACKGROUND

### Field of Invention

This disclosure relates to a hardware device, and in particular to an antenna device.

### Description of Related Art

In order to pursue narrow borders and optimal space utilization, the antennas of tablets and notebooks are typically configured along the periphery of the panels. To suppress system noise, filters are indispensable components of radio frequency modules. However, the use of conventional filters has the problem of taking up space and having high assembly costs.

As such, the related art has inconveniences and defects that need to be addressed. In order to resolve the above problems, people having ordinary skills in the art have spared no efforts to seek solutions, but for a long time no suitable methods have been developed. Therefore, how to save space and reduce costs are important research and development topics and goals to improve in the related fields.

### SUMMARY

The present disclosure provides an innovative antenna device to solve the problems mentioned in the related art.

The present disclosure provides an antenna device. The antenna device comprises an antenna pattern and a microstrip filter. The microstrip filter is disposed on a display panel surface, and the microstrip filter is electrically connected to the antenna pattern.

In some embodiments, the antenna pattern comprises a first antenna pattern. The first antenna pattern is disposed on a top cover, and one side of the top cover is connected to the display panel surface.

In some embodiments, the antenna pattern further comprises a second antenna pattern. The second antenna pattern is disposed on a back cover, another side of the top cover is connected to the back cover, and the back cover and the display panel surface are opposite to each other.

In some embodiments, the antenna device further comprises an outgoing line terminal. The outgoing line terminal is electrically connected to the microstrip filter.

In some embodiments, the microstrip filter comprises: a plurality of strip microstrips. The strip microstrips are arranged on the display panel surface at intervals, and at least a portion of any one of the plurality of strip microstrips is located beside at least a portion of an adjacent one of the plurality of strip microstrips.

In some embodiments, the microstrip filter comprises a plurality of U-shaped microstrips. The U-shaped microstrips are arranged on the display panel surface at intervals, and an opening direction of a notch of any one of the plurality of U-shaped microstrips is opposite to an opening direction of a notch of an adjacent one of the plurality of U-shaped microstrips.

In some embodiments, the microstrip filter comprises a first microstrip and a second microstrip. The first microstrip comprises a plurality of first finger-shaped portions that are arranged at intervals. The second microstrip comprises a plurality of second finger-shaped portions that are arranged at intervals, the second finger-shaped portions and the first finger-shaped portions are parallel to each other and arranged alternately.

In some embodiments, the microstrip filter comprises a microstrip. The microstrip comprises a plurality of columnar components and a plurality of connecting wires, the plurality of columnar components are connected to each other through the plurality of connecting wires.

In some embodiments, the microstrip filter comprises a first U-shaped microstrip, a second U-shaped microstrip, a third U-shaped microstrip, a fourth U-shaped microstrip and a fifth U-shaped microstrip. The second U-shaped microstrip is located at one side of the first U-shaped microstrip, an opening direction of a notch of the first U-shaped microstrip is opposite to an opening direction of a notch of the second U-shaped microstrip. The third U-shaped microstrip, located at another side of the first U-shaped microstrip, the opening direction of the notch of the first U-shaped microstrip is opposite to an opening direction of a notch of the third U-shaped microstrip. One terminal of the second U-shaped microstrip is located in a notch of the fourth U-shaped microstrip. One terminal of the third U-shaped microstrip is located in a notch of the fifth U-shaped microstrip.

The present disclosure provides another antenna device. The antenna device comprises an antenna pattern, a microstrip filter and an outgoing line terminal. The antenna pattern is disposed on at least one of a top cover or a back cover. The microstrip filter is disposed on a display panel surface, wherein one terminal of the microstrip filter is electrically connected to the antenna pattern, and the back cover and the display panel surface are respectively located on opposite sides of the top cover. The outgoing line terminal is electrically connected to another terminal of the microstrip filter.

In some embodiments, the microstrip filter comprises a plurality of strip microstrips. The strip microstrips are arranged on the display panel surface at intervals, and at least a portion of any one of the plurality of strip microstrips is located beside at least a portion of an adjacent one of the plurality of microstrips.

In some embodiments, the microstrip filter comprises a plurality of U-shaped microstrips. The U-shaped microstrips are arranged on the display panel surface at intervals, and an opening direction of a notch of any one of the plurality of U-shaped microstrips is opposite to an opening direction of a notch of an adjacent one of the plurality of U-shaped microstrips.

In some embodiments, the microstrip filter comprises a first microstrip and a second microstrip. The first microstrip comprises a plurality of first finger-shaped portions that are arranged at intervals. The second microstrip comprises a plurality of second finger-shaped portions that are arranged at intervals, the second finger-shaped portions and the first finger-shaped portions are parallel to each other and arranged alternately.

In some embodiments, the microstrip filter comprises a microstrip. The microstrip comprises a plurality of columnar components and a plurality of connecting wires, the plurality of columnar components are connected to each other through the plurality of connecting wires.

In some embodiments, the microstrip filter comprises a first U-shaped microstrip, a second U-shaped microstrip, a third U-shaped microstrip, a fourth U-shaped microstrip and a fifth U-shaped microstrip. The second U-shaped microstrip is located at one side of the first U-shaped microstrip, an opening direction of a notch of the first U-shaped microstrip is opposite to an opening direction of a notch of the second U-shaped microstrip. The third U-shaped microstrip, located at another side of the first U-shaped microstrip, the opening direction of the notch of the first U-shaped microstrip is opposite to an opening direction of a notch of the third U-shaped microstrip. One terminal of the second U-shaped microstrip is located in a notch of the fourth U-shaped microstrip. One terminal of the third U-shaped microstrip is located in a notch of the fifth U-shaped microstrip.

In summary, the technical solution of the present disclosure has obvious advantages and beneficial effects compared with the related art. By integrating the filter and the antenna together through the antenna device of the present disclosure, the space between the substrate and the filter can be saved, which has advantages in space utilization. Furthermore, it can also reduce costs and simplify circuit design in the research and development stage, making the device easier for the factory to assemble and accordingly reducing the assembly labor cost.

The above description will be described in detail below with reference to implementation embodiments, and a further explanation will be provided for the technical solution of the present disclosure.

### BRIEF DESCRIPTION OF THE DRAWINGS

In order to make the above and other objects, features, advantages and embodiments of the present disclosure more clearly understood, the accompanying figures are described as follows:

FIG. 1 is a plan view of an electronic device according to an embodiment of the present disclosure.

FIG. 2 is a perspective view of an antenna device at a first viewing angle according to an embodiment of the present disclosure.

FIG. 3 is a perspective view of an antenna device at a second viewing angle according to an embodiment of the present disclosure.

FIG. 4 is a plan view of a microstrip filter according to an embodiment of the present disclosure.

FIG. 5 is a plan view of a microstrip filter according to an embodiment of the present disclosure.

FIG. 6 is a plan view of a microstrip filter according to an embodiment of the present disclosure.

FIG. 7 is a plan view of a microstrip filter according to an embodiment of the present disclosure.

### DETAILED DESCRIPTION

The embodiments are described in detail below with reference to the appended drawings to better understand the aspects of the present disclosure. However, the embodiments provided are not intended to limit the scope of the disclosure, and the description of the structural operation is not intended to limit the order in which they are performed. Any device that has been recombined by components and produces an equivalent function is within the scope covered by the disclosure.

The terms used in the entire specification and the scope of the patent application, unless otherwise specified, generally have the ordinary meaning of each term used in the field, the content disclosed herein, and the particular content.

The terms “coupled” or “connected” as used herein may mean that two or more elements are directly in physical or electrical contact or are indirectly in physical or electrical contact with each other. It can also mean that two or more elements interact with each other.

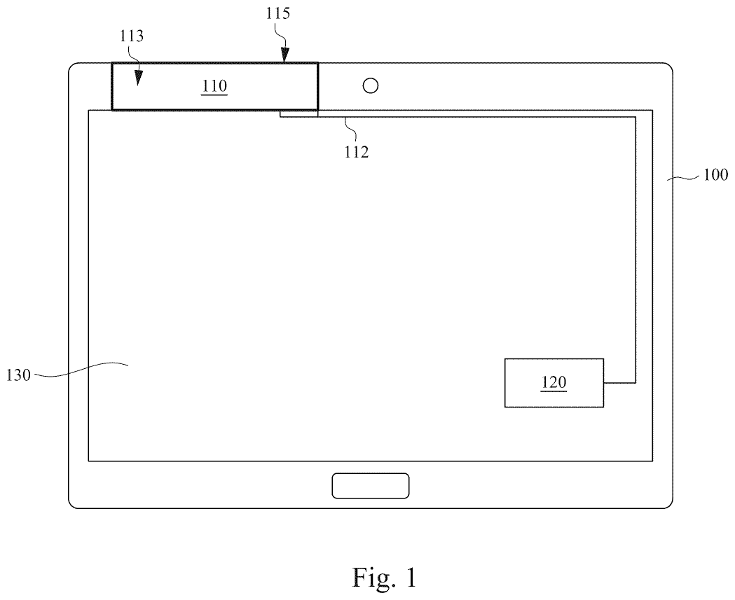

Reference is made to FIG. 1. The technical aspect of the present disclosure is an antenna device 110, which can be applied to various electronic devices 100 with wireless communication functions, or widely configured in related technical purposes. The antenna device 110 of this technical aspect can achieve considerable technical progress and has wide industrial application value. The specific implementation of the antenna device 110 will be described below with reference to FIGS. 1, 2, and 3.

It should be understood that various embodiments of the antenna device 110 are described in conjunction with FIGS. 1, 2, and 3. In the following description, for ease of explanation, numerous specific details are further set forth in order to provide a thorough description of one or more embodiments. However, the present technology may be practiced without these specific details. In other embodiments, known structures and devices are shown in block diagram form in order to efficiently describe these embodiments. The word “for example” is used herein to mean “serving as an example, instance or illustration”. Any embodiment described herein as “for example” is not necessarily to be construed as preferred or advantageous over other embodiments.

Reference is made to FIG. 1. FIG. 1 is a plan view of an electronic device 100 according to an embodiment of the present disclosure. In practice, for example, the electronic device 100 may be applied to a notebook computer, a monitor, a mobile phone, a tablet computer or other electronic products.

As shown in FIG. 1, the electronic device 100 includes an antenna device 110, a radio frequency module 120, and a display panel 130. In terms of structure, the antenna device 110 is disposed around the display panel 130, and the radio frequency module 120 is disposed on a substrate below the display panel 130.

In some embodiments of the present disclosure, the antenna device 110 integrates a microstrip filter and an antenna, and an outgoing line terminal 112 of the antenna device 110 is electrically connected to the radio frequency module 120. In a controlled experiment, the antenna is connected to an external filter on a substrate through a set of lines, and the external filter was connected to the radio frequency modules through another set of lines. This may cause additional losses, and the external filter and its substrate may take up additional space and the assembly cost may be high. Compared to the control experiment mentioned above, the antenna device 110 of the present disclosure integrates the microstrip filter and the antenna together to save space on the substrate and the filter, which has advantages in space utilization, and it can also reduce costs and simplify circuit design in the research and development stage. Also, the antenna device 110 is simpler to assemble in the factory, so the assembly labor cost can be reduced.

It should be understood that in the embodiments and the scope of the patent application, the description involving “electrically connect” may generally refer to an element being indirectly electrically coupled to another element through other elements, or an element being directly electrically connected to another element without going through other elements. For example, the outgoing line terminal 112 of the antenna device 110 may be directly physically connected to the radio frequency module 120, or the outgoing line terminal 112 of the antenna device 110 may be indirectly electrically coupled to the radio frequency module 120 through a line.

In practice, considering the antenna efficiency, in some embodiments of the present disclosure, the display panel surface 113 of the antenna device 110 may not be designed with an antenna, but it is used to configure a microstrip filter. The display panel surface 113 of the antenna device 110 and the display panel 130 toward the same direction, the display panel surface 113 may be covered by a frame of the electronic device 100, and the display panel surface 113 of the antenna device 110 is substantially perpendicular to a top cover 115 of the antenna device 110.

As used herein, “about”, “approximately” or “substantially” are used to modify any quantity that may vary slightly, but such slight variation will not change its essence. If there is no special explanation in the embodiments, the error range of the numerical value modified by “about”, “approximately” or “substantially” is generally allowed within 20%, preferably within 10%, and more preferably within 5%.

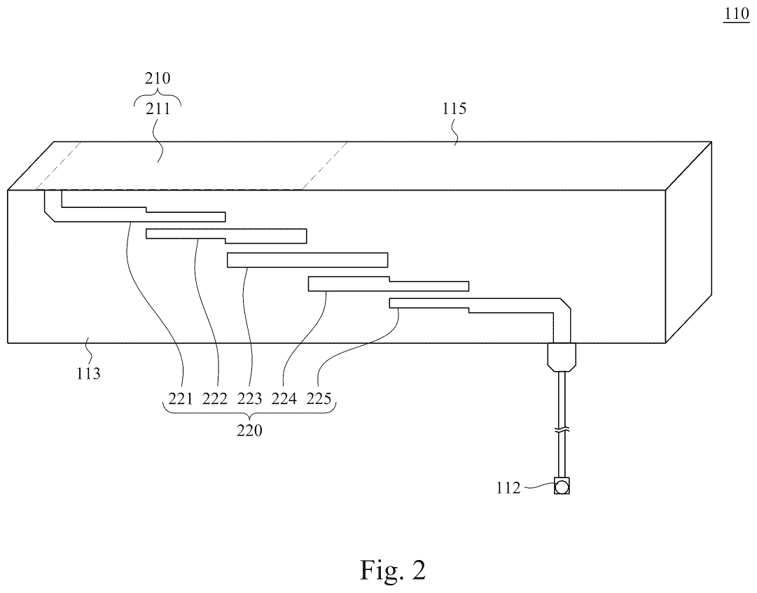

To further explain the configuration of the microstrip filter of the antenna device 110, please refer to FIGS. 1 and 2 at the same time. FIG. 2 is a perspective view of an antenna device 110 at a first viewing angle according to an embodiment of the present disclosure. As shown in FIG. 2, the antenna device 110 includes an antenna pattern 210 and a microstrip filter 220. In terms of structure, the microstrip filter 220 is disposed on the display panel surface 113, and the microstrip filter 220 is electrically connected to the antenna pattern 210.

In some embodiments of the present disclosure, the antenna device 110 further includes an outgoing line terminal 112. In terms of structure, the outgoing line terminal 112 is electrically connected to the microstrip filter 220.

Regarded to the structure of the antenna pattern 210, in some embodiments of the present disclosure, the antenna pattern 210 includes a first antenna pattern 211 (e.g., a first antenna metal pattern layer). In terms of structure, one side of the top cover 115 is connected to the display panel surface 113. The first antenna pattern 211 is disposed on the top cover 115, which has better antenna performance and is away from interference from the display panel 130 in FIG. 1.

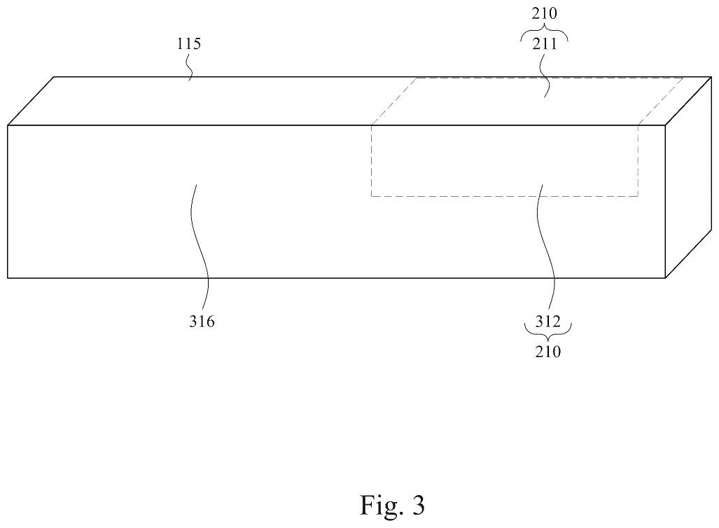

To further explain the configuration of the antenna pattern 210 mentioned above, please refer to FIGS. 1, 2, and 3 at the same time. FIG. 3 is a perspective view of an antenna device 110 at a second viewing angle according to an embodiment of the present disclosure. As shown in FIG. 3, another side of the top cover 115 is connected to the back cover 316, and the back cover 316 in FIG. 3 and the display panel surface 113 in FIG. 2 are opposite to each other. The antenna pattern 210 further includes a second antenna pattern 312 (e.g., a second antenna metal pattern layer). In terms of structure, the second antenna pattern 312 is disposed on the back cover 316, which has better antenna performance and is away from the interference of the display panel 130 in FIG. 1.

It should be understood that in the implementation manner and the scope of the patent application, descriptions such as “first”, “second”, etc. are used to avoid confusion between elements, and the terms do not limit the number or advantages and disadvantages of the elements.

In summary, please refer to FIGS. 1, 2, and 3 at the same time. In some embodiments of the present disclosure, the antenna device 110 may include the antenna pattern 210, the microstrip filter 220, and the outgoing line terminal 112. In terms of structure, the antenna pattern 210 is disposed on at least one of the top cover 115 and the back cover 316. The microstrip filter 220 is disposed on the display panel surface 113. One terminal of the microstrip filter 220 is electrically connected to the antenna pattern 210, and the outgoing line terminal 112 is electrically connected to another terminal of the microstrip filter 220. The back cover 316 and the display panel surface 113 are respectively located on opposite sides of the top cover 115.

To further explain the structure of the microstrip filter 220, please continue referring to FIG. 2. As shown in FIG. 2, in some embodiments of the present disclosure, a microstrip filter 220 includes a plurality of strip microstrips 221~225. In terms of structure, the strip microstrips 221~225 are arranged on the display panel surface 113 at intervals, and at least a portion of any one of the strip microstrips 221~225 is located beside at least a portion of an adjacent one of the microstrips.

For example, the portion of the strip microstrip 221 is located beside the portion of the strip microstrip 222, the other portion of the strip microstrip 222 is located beside the portion of the strip microstrip 223, the other portion of the strip microstrip 223 is located beside the portion of the strip microstrip 224, and the other portion of the strip microstrip 224 is located beside the portion of the strip microstrip 225. One terminal of the strip microstrip 221 is electrically connected to the antenna pattern 210, and one terminal of the strip microstrip 225 is electrically connected to the outgoing line terminal 112.

Regarded to the design of the microstrip filter 220, to achieve this technology, it is necessary to replace the conventional filter composed of inductors and capacitors with microstrips (such as the strip microstrip 221~225).

A microstrip inductor can be implemented by designing microstrips with appropriate length and width. The inductance (L) is related to the length (l) and characteristic impedance (Zo) of the microstrip. The calculation formula for inductance is: L=Zo×l/c, where c is the speed of light.

Microstrip capacitance can be implemented by designing parallel microstrips with appropriate spacing and length. The capacitance value (C) is related to the spacing (d) and length (l) of the microstrip. The calculation formula for capacitance value is: C=εr×εo×l/d, where εr is the dielectric constant and εo is the permittivity in vacuum.

In practice, for example, the microstrip filter 220 can be directly implemented on a flexible printed circuit (FPC) without requiring additional resistors, inductors and/or capacitors, and without incurring additional process costs. The filter function can be achieved by changing the impedance of the transmission line (e.g., the strip microstrip 221~225).

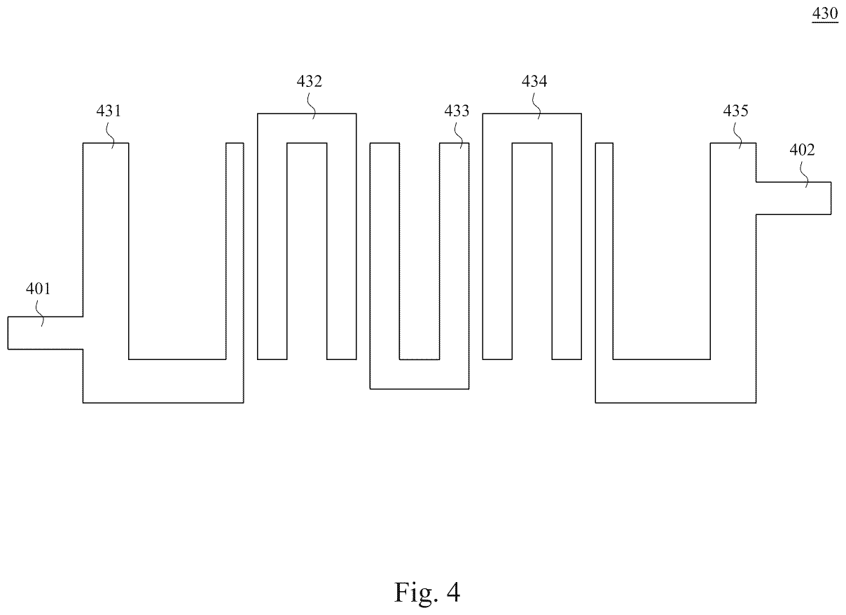

FIG. 4 is a plan view of a microstrip filter 430 according to an embodiment of the present disclosure. As shown in FIG. 4, the microstrip filter 430 includes a plurality of U-shaped microstrips 431~435. In some embodiments of the present disclosure, the microstrip filter 430 of FIG. 4 may replace the microstrip filter 220 of FIG. 2. In terms of structure, the U-shaped microstrips 431~435 are arranged on the display panel surface 113 at intervals, and the opening direction of notch of any one of the U-shaped microstrips 431~435 is opposite to the opening direction of notch of an adjacent U-shaped microstrip.

For example, the opening direction of a notch of the U-shaped microstrip 431 is opposite to the opening direction of a notch of the adjacent U-shaped microstrip 432, the opening direction of the notch of the U-shaped microstrip 432 is opposite to the opening direction of a notch of the adjacent U-shaped microstrip 433, the opening direction of the notch of the U-shaped microstrip 433 is opposite to the opening direction of a notch of the adjacent U-shaped microstrip 434, and the opening direction of the notch of the U-shaped microstrip 434 is opposite to the opening direction of a notch of the adjacent U-shaped microstrip 435. One terminal of the first connecting microstrip 401 is connected to the U-shaped microstrip 431, and another terminal of the first connecting microstrip 401 can be connected to the first antenna pattern 211 of the antenna pattern 210 of FIG. 2. One terminal of the second connecting microstrip 402 is connected to the U-shaped microstrip 435, and another terminal of the second connecting microstrip 402 can be connected to the outgoing line terminal 112 of FIG. 2.

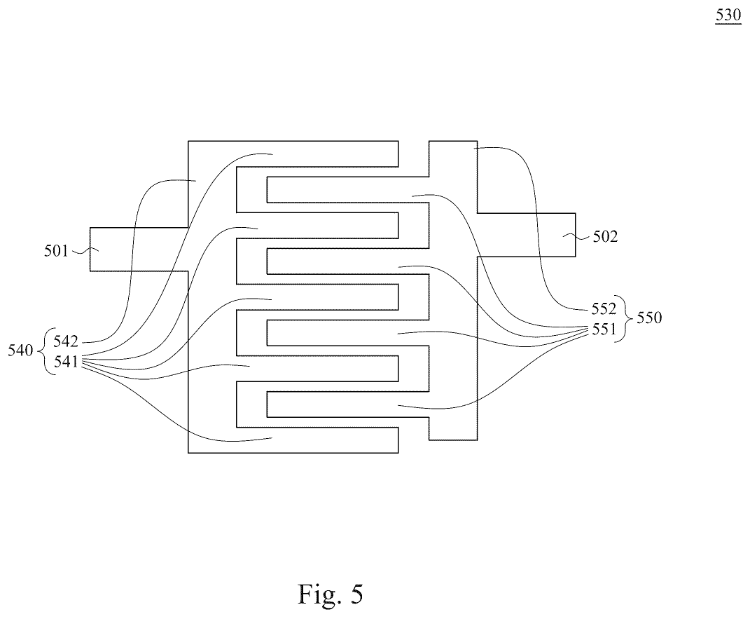

FIG. 5 is a plan view of a microstrip filter 530 according to an embodiment of the present disclosure. As shown in FIG. 5, the microstrip filter 530 includes a first microstrip 540 and a second microstrip 550. In terms of structure, the first microstrip 540 includes a plurality of first finger-shaped portions 541 arranged at intervals. The second microstrip 550 includes a plurality of second finger-shaped portions 551 arranged at intervals. The second finger-shaped portions 551 and the first finger-shaped portions 541 are parallel to each other and arranged alternately.

As shown in FIG. 5, the first microstrip 540 includes a first connecting component 542, and the first connecting component 542 connects the first finger-shaped portions 541. In some embodiments of the present disclosure, the microstrip filter 530 of FIG. 5 may replace the microstrip filter 220 of FIG. 2. For example, one terminal of the first connecting microstrip 501 is connected to the first connecting component 542, and another terminal of the first connecting microstrip 501 can be connected to the first antenna pattern 211 of the antenna pattern 210 of FIG. 2.

As shown in FIG. 5, the second microstrip 550 includes a second connecting component 552, and the second connecting component 552 connects the second finger-shaped portions 551. In some embodiments of the present disclosure, the microstrip filter 530 of FIG. 5 may replace the microstrip filter 220 of FIG. 2. For example, one terminal of the second connecting microstrip 502 is connected to the second connecting component 552, and another terminal of the second connecting microstrip 502 can be connected to the outgoing line terminal 112 of FIG. 2.

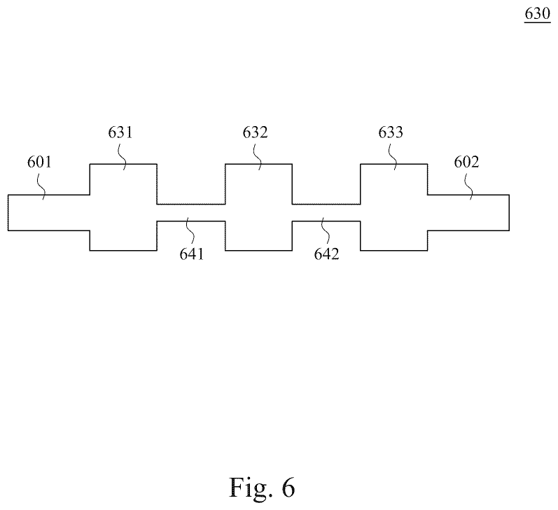

FIG. 6 is a plan view of a microstrip filter according to an embodiment of the present disclosure. As shown in FIG. 6, the microstrip filter 630 includes a microstrip, which includes a plurality of columnar components 631~633 and a plurality of connecting lines 641, 642. The columnar components 631~633 are connected to each other through the connecting lines 641, 642.

In some embodiments of the present disclosure, the microstrip filter 630 of FIG. 6 may replace the microstrip filter 220 of FIG. 2. For example, one terminal of the first connecting microstrip 601 can be connected to the first antenna pattern 211 of the antenna pattern 210 of FIG. 2, and another terminal of the first connecting microstrip 601 is connected to one side of the columnar component 631. One terminal of the connecting line 641 is connected to another side of the columnar component 631, and another terminal of the connecting line 641 is connected to one side of the columnar component 632. One terminal of the connecting line 642 is connected to another side of the columnar component 632, and another terminal of the connecting line 642 is connected to one side of the columnar component 633. One terminal of a second connecting microstrip 602 is connected to another side of the columnar component 633, and another terminal of the second connecting microstrip 602 can be connected to the outgoing line terminal 112 of FIG. 2.

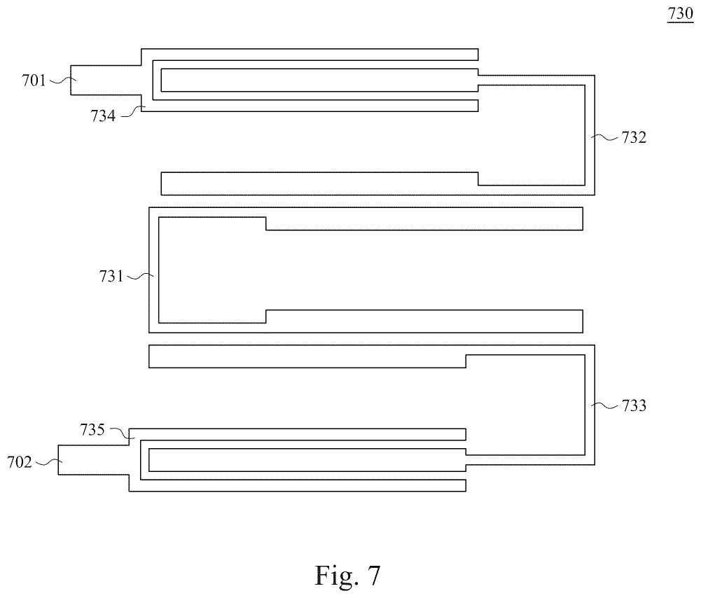

FIG. 7 is a plan view of a microstrip filter 730 according to an embodiment of the present disclosure. As shown in FIG. 7, the microstrip filter 730 includes a first U-shaped microstrip 731, a second U-shaped microstrip 732, a third U-shaped microstrip 733, a fourth U-shaped microstrip 734, and a fifth U-shaped microstrip 735.

In terms of structure, the second U-shaped microstrip 732 is located at one side of the first U-shaped microstrip 731, and the opening direction of a notch of the first U-shaped microstrip 731 is opposite to the opening direction of a notch of the second U-shaped microstrip 732. The third U-shaped microstrip 733 is located at another side of the first U-shaped microstrip 731, and the opening direction of the notch of the first U-shaped microstrip 731 is opposite to the opening direction of a notch of the third U-shaped microstrip 733. One terminal of the second U-shaped microstrip 732 is located in a notch of the fourth U-shaped microstrip 734, and one terminal of the third U-shaped microstrip 733 is located in a notch of the fifth U-shaped microstrip 735.

In some embodiments of the present disclosure, the microstrip filter 730 of FIG. 7 may replace the microstrip filter 220 of FIG. 2. For example, one terminal of the first connecting microstrip 701 can be connected to the first antenna pattern 211 of the antenna pattern 210 in FIG. 2, another terminal of the first connecting microstrip 701 is connected to bottom of the notch of the fourth U-shaped microstrip 734, one terminal of the second connecting microstrip 702 is connected to bottom of the notch of the fifth U-shaped microstrip 735, and another terminal of the second connecting microstrip 702 can be connected to the outgoing line terminal 112 in FIG. 2.

In summary, the technical solution of the present disclosure has obvious advantages and beneficial effects compared with the related art. By integrating the filter and the antenna together through the antenna device of the present disclosure, the space between the substrate and the filter can be saved, which has advantages in space utilization. Furthermore, it can also reduce costs and simplify circuit design in the research and development stage, making the device easier for the factory to assemble and accordingly reducing the assembly labor cost.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present disclosure cover modifications and variations of this invention provided they fall within the scope of the following claims.

What is claimed is:

1. An antenna device comprising:
an antenna pattern; and
a microstrip filter, disposed on a display panel surface, and the microstrip filter is electrically connected to the antenna pattern.

2. The antenna device of claim 1, wherein the antenna pattern comprises:
a first antenna pattern, disposed on a top cover, and one side of the top cover is connected to the display panel surface.

3. The antenna device of claim 2, wherein the antenna pattern further comprises:
a second antenna pattern, disposed on a back cover, another side of the top cover is connected to the back cover, and the back cover and the display panel surface are opposite to each other.

4. The antenna device of claim 1, further comprising:
an outgoing line terminal, electrically connected to the microstrip filter.

5. The antenna device of claim 1, wherein the microstrip filter comprises:
a plurality of strip microstrips, arranged on the display panel surface at intervals, and at least a portion of any one of the plurality of strip microstrips is located beside at least a portion of an adjacent one of the plurality of strip microstrips.

6. The antenna device of claim 1, wherein the microstrip filter comprises:
a plurality of U-shaped microstrips, arranged on the display panel surface at intervals, and an opening direction of a notch of any one of the plurality of U-shaped microstrips is opposite to an opening direction of a notch of an adjacent one of the plurality of U-shaped microstrips.

7. The antenna device of claim 1, wherein the microstrip filter comprises:
a first microstrip, comprising a plurality of first finger-shaped portions that are arranged at intervals; and
a second microstrip, comprising a plurality of second finger-shaped portions that are arranged at intervals, the second finger-shaped portions and the first finger-shaped portions are parallel to each other and arranged alternately.

8. The antenna device of claim 1, wherein the microstrip filter comprises:
a microstrip, comprising a plurality of columnar components and a plurality of connecting wires, wherein the plurality of columnar components are connected to each other through the plurality of connecting wires.

9. The antenna device of claim 1, wherein the microstrip filter comprises:
a first U-shaped microstrip;
a second U-shaped microstrip, located at one side of the first U-shaped microstrip, wherein an opening direction of a notch of the first U-shaped microstrip is opposite to an opening direction of a notch of the second U-shaped microstrip;
a third U-shaped microstrip, located at another side of the first U-shaped microstrip, wherein the opening direction of the notch of the first U-shaped microstrip is opposite to an opening direction of a notch of the third U-shaped microstrip;
a fourth U-shaped microstrip, wherein one terminal of the second U-shaped microstrip is located in a notch of the fourth U-shaped microstrip; and
a fifth U-shaped microstrip, wherein one terminal of the third U-shaped microstrip is located in a notch of the fifth U-shaped microstrip.

10. An antenna device comprising:
an antenna pattern, disposed on at least one of a top cover or a back cover;
a microstrip filter, disposed on a display panel surface, wherein one terminal of the microstrip filter is electrically connected to the antenna pattern, and the back cover and the display panel surface are respectively located on opposite sides of the top cover; and
an outgoing line terminal, electrically connected to another terminal of the microstrip filter.

11. The antenna device of claim 10, wherein the microstrip filter comprises:
a plurality of strip microstrips, arranged on the display panel surface at intervals, and at least a portion of any one of the plurality of strip microstrips is located beside at least a portion of an adjacent one of the plurality of strip microstrips.

12. The antenna device of claim 10, wherein the microstrip filter comprises:
a plurality of U-shaped microstrips, arranged on the display panel surface at intervals, and an opening direction of a notch of any one of the plurality of U-shaped microstrips is opposite to an opening direction of a notch of an adjacent one of the plurality of U-shaped microstrips.

13. The antenna device of claim 10, wherein the microstrip filter comprises:
a first microstrip, comprising a plurality of first finger-shaped portions that are arranged at intervals; and
a second microstrip, comprising a plurality of second finger-shaped portions that are arranged at intervals, the second finger-shaped portions and the first finger-shaped portions are parallel to each other and arranged alternately.

14. The antenna device of claim 10, wherein the microstrip filter comprises:
a microstrip, comprising a plurality of columnar components and a plurality of connecting wires, wherein the plurality of columnar components are connected to each other through the plurality of connecting wires.

15. The antenna device of claim 10, wherein the microstrip filter comprises:
a first U-shaped microstrip;
a second U-shaped microstrip, located at one side of the first U-shaped microstrip, wherein an opening direction of a notch of the first U-shaped microstrip is opposite to an opening direction of a notch of the second U-shaped microstrip;
a third U-shaped microstrip, located at another side of the first U-shaped microstrip, wherein the opening direction of the notch of the first U-shaped microstrip is opposite to an opening direction of a notch of the third U-shaped microstrip;
a fourth U-shaped microstrip, wherein one terminal of the second U-shaped microstrip is located in a notch of the fourth U-shaped microstrip; and
a fifth U-shaped microstrip, wherein one terminal of the third U-shaped microstrip is located in a notch of the fifth U-shaped microstrip.
